(19) United States
(12) Patent Application Publication
(10) Pub. No.: US 2010/0147795 A1
(43) Pub. Date: Jun. 17, 2010

(54) METHOD FOR THE SELECTIVE SURFACE TREATMENT OF NON-FLAT WORKPIECES

(76) Inventor: Claus Peter Kluge, Roslau (DE)

Correspondence Address: FULBRIGHT & JAWORSKI, LLP, 666 FIFTH AVE, NEW YORK, NY, 10103-3198, US

(21) Appl. No.: 12/596,843

(22) PCT Filed: Apr. 17, 2008
(86) PCT No.: PCT/EP08/54623

§ 371 Date: Oct. 27, 2009

(30) Foreign Application Priority Data
Apr. 24, 2007 (DE) 102007019634.4

(51) Int. Cl. B44C 1/22; C25D 5/02; B05D 1/32

(52) U.S. Cl. 216/41; 205/136; 427/282

(57) ABSTRACT

A method for the selective surface treatment of a first workpiece on at least one of the metalized areas of the upper and/or underside, the first workpiece being releasably jointed to at least one additional workpiece on one of its faces so as to be sealed from the exterior in at least one partial area and the selective surface treatment of the areas not covered by the joined section being carried out in a treatment phase. Cooling and distribution of the metalized areas is made easier because the first workpiece is not flat and has on at east one face identically or different metalized areas or cavities across a whole or part of a surface. It also has at least one additional metallic protective layer or an additional metallic coating applied during the selective surface treatment.

The invention relates to a method for the selective surface-treatment of a workpiece in accordance with the preamble of claim 1.

Such a method of the generic type for the selective surface-treatment of workpieces is known from DE 101 54 316 A1.

This method for the selective surface-treatment of a plate-shaped workpiece on at least one of two metallic surface sides is characterised in that at least two workpieces of the same kind are connected together in a releasable manner on one of their first surface sides at least in a partial region, in an outwardly sealed manner, and in that then the selective surface-treatment of the regions of the metallic surface sides not covered by the connection is effected in a treatment phase.

After the structuring of a copper foil, in one method step the selective surface-treatment of just certain metallized coatings is effected, not, however, of those metallized coatings for which no surface-treatment is intended. For this, two multiple substrates are connected together in each case with their side that has the metallized coatings, for which no surface-treatment is intended, by way of a connecting element in a tight, but re-releasable manner, that is, in such a way that the metallized coatings for which no surface-treatment is intended are completely covered outwardly by means of a connecting element.

The metallized coatings for which no surface-treatment is intended are located in the space which is tightly closed by the connecting element and the ceramic layers of the two multiple substrates so that the subsequent surface-treatment is effected merely at the exposed metallized coatings on which the surface-treatment is to be carried out.

DE 101 54 316 A1 merely describes plate-shaped workpieces with a one- or two-sided metallized coating which builds on two identical plate-shaped workpieces.

The underlying object of the invention is to develop further a method in accordance with the preamble of claim 1 in such a way that better cooling and greater ease of distribution of the metallized regions are possible.

In accordance with the invention this object is achieved in that at least the first workpiece is formed so that it is not plate-shaped and on at least one side over the whole or part of the surface is provided with identically or differently metallized or non-metallized areas or cavities or combinations thereof, and at least one further metallic cover or a further metallic coating is applied during the selective surface-treatment. As a result of the non-plate-shaped formation of the first workpiece, it is possible to achieve not only better cooling, but also better distribution of the metallized regions. The improved cooling can be achieved by means of any configurations of the surface. Departure from the plate-shaped configuration of the workpiece always results in an enlarged surface and thus in an improvement in the cooling and the provision of more useful area.

In development of the invention, the upper sides and the lower sides of the workpieces are formed in such a way that they each have surfaces of differing size.

In a special inventive configuration, one of the sides of the first workpiece and/or one of the sides of the other workpieces are/is formed with a planar surface.

At least one of the other workpieces that is connected to the first workpiece can also be formed in a plate-shaped manner.

In a preferred embodiment, the selective surface-treatment is carried out by chemical and/or electrolytic deposition, or combinations thereof, of at least one metallic coating.

In an inventive configuration, the sealed and re-releasable connection of the first workpiece with at least one other workpiece is effected in such a way that as a result at least one surface of the first workpiece is covered by the connection over the whole or part of the surface.

Advantageously, at least some of the workpieces are produced from metal, ceramic material, polymers or combinations thereof. Ceramic material has proved to be particularly advantageous.

At least the first workpiece is preferably an equipped or non-equipped electrically non-conductive or almost non-conductive circuit-carrier and bears at least one metallization over the whole or part of at least one surface.

In a configuration of the invention, at least the first workpiece, but preferably also the other workpieces, is/are a ceramic-material/metal substrate. A metal/ceramic-material substrate is known, for example, from DE 10 2004 033227 A1.

At least the first workpiece is preferably provided at one point with a metallization which is connected to the workpiece by the DCB (direct copper bonding) method or the AMB (active metal brazing) method.

Advantageously, for the re-releasable connection of the first workpiece with at least one other workpiece a frame- or plate-like connecting element is used that corresponds to the negative contour of the surface of the first workpiece that is to be covered and on which the other workpieces are held with use of an adhesive and/or gluing and/or sealing mass and/or with use of low pressure.

In a configuration of the invention, a plurality of temporally successive treatment phases of the same or a different selective surface-treatment are carried out, wherein before each treatment phase of the selective surface-treatment the workpieces are tightly connected together at their surface sides which are not to be treated.

An inventive configuration is characterised in that a plurality of temporally successive treatment phases of the same or a different selective treatment, also subtractive processes, such as etching processes, are carried out on the regions which are not covered.

Preferably, as a result of corresponding geometrical arrangement of the workpieces at the same time or alternately at least two different selective surface-treatments are carried out.

Advantageously, at least one workpiece is a ceramic heat sink.

What is understood by a heat sink is a carrier body for electrical or electronic structural elements or circuit arrangements, wherein the carrier body electrically is not or is almost not conductive and the carrier body is provided with heat-dissipating or heat-supplying cooling elements in one piece therewith. The carrier body is preferably a printed circuit board and the cooling elements are bores, channels, ribs and/or clearances on which a heating or cooling medium can act. The carrier body and/or the cooling element consist/consists, for example, of at least one ceramic component or a composite of different ceramic materials. Heat sinks are described, for example, in DE 10 2007 014433 A1 or DE 37 09 200 A1.

The invention is explained in greater detail in the following with reference to two figures.

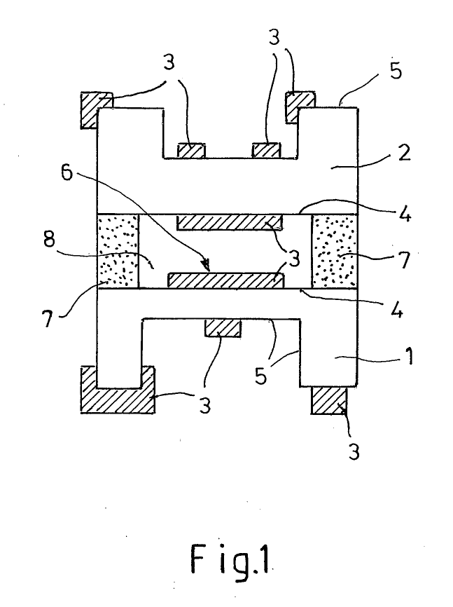

FIG. 1 shows a first workpiece 1 with various metallized regions or metallized coatings 3. For the selective surface-treatment of the first workpiece 1 on at least one of the metallized regions 3 of its upper side 4 and/or lower side 5, the region 6 which is not to be treated is covered. For this purpose, in the embodiment shown here, use is made of one single other workpiece 2 which likewise has metallized coatings 3 on its sides. This other workpiece 2 is set onto the regions 3, which are not to be treated, by way of a sealing element 7 in such a way that these regions 3 are covered. The connection is effected in such a way that the other workpiece 2 can be removed again from the first workpiece 1.

After the connection or covering of the regions 6 which are not to be treated, the selective surface-treatment of the regions not covered by the connection is then effected in a treatment phase. The selective surface-treatment is preferably carried out by chemical and/or electrolytic deposition, or combinations thereof, of at least one metallic coating.

In accordance with the invention, the first workpiece 1 is formed so that it is not plate-shaped. In the embodiment shown here, the other workpiece 2 is also formed so that it is not plate-shaped. Being not plate-shaped means that the upper sides 4 and the lower sides 5 of the workpieces 1, 2 are formed in such a way that they each have surfaces of differing size. The upper sides 4 of the first workpiece 1 and of the other workpiece 2 in this case have a planar surface. The space 8 that is located between the first workpiece 1 and the other workpiece 2 and is sealed by way of the sealing elements 7 can also be provided with a low or under-pressure in order to improve the holding connection.

The workpieces that are shown here are produced from a ceramic material and are a ceramic ceramic-material/metal-substrate or a heat sink.

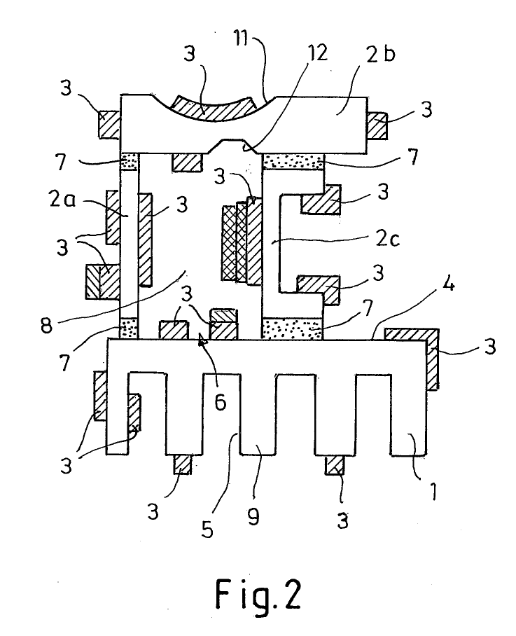

FIG. 2 shows a first workpiece 1 consisting of a ceramic material that has a planar upper side 4. Applied to this upper side 4 there are various metallized regions 3, and the upper side 4 is a circuit carrier. The lower side 5 of the first workpiece 1 has cooling ribs 9 and is a heat sink. Heat sinks are described, for example, in DE 10 2007 014433 A1.

For the purposes of the selective surface-treatment, the metallized coatings 6 that are not to be treated are covered with other workpieces 2a, 2b, 2c. These other workpieces 2a, 2b, 2c are connected with the first workpiece 1 and one with the other by way of sealing elements 7. The first workpiece 1 is formed so that it is not plate-shaped, and its upper side 4 has a different area size from its lower side 5.

The other workpiece 2a is formed so that it is plate-shaped. The other workpieces 2b, 2c are formed so that they are not plate-shaped. Both the first workpiece 1 and the other workpieces 2 have metallized coatings 3 on all of their sides. In part, these metallized coatings 3 are also provided with further metallized coatings or with structural elements.

The other workpiece 2b is also produced from a ceramic material and on its sides in each case has a clearance 10, 11. The clearance 10 is formed so that it is conical and the clearance 11 is formed so that it is spherical. The other workpiece 2c is formed so that it is U-shaped. Here as well, the sealed space is marked by the reference numeral 8.

1-15. (canceled)

16. A method for the selective surface-treatment of a first workpiece on at least one of the metallized regions of its upper side or lower side, wherein the first workpiece is connected in a releasable manner together with at least one other workpiece on at least one side thereof at least in a partial region, in an outwardly sealed manner, and the selective surface-treatment of the regions not covered by the connection is effected in a treatment phase, wherein at least the first workpiece is formed so that it is not plate-shaped and on at least one side over the whole or part of the surface is provided with identically or differently metallized or non-metallized regions or cavities or a combination thereof, and at least one further metallic cover or a further metallic coating is applied during the selective surface-treatment.

17. A method according to claim 16, wherein the upper sides and the lower sides of the workpieces are formed in such a way that they each have surfaces of differing size.

18. A method according to claim 16, wherein one of the sides of the first workpiece or one of the sides of the other workpieces are foamed with a planar surface.

19. A method according to claim 16, wherein at least one of the other workpieces that is connected to the first workpiece is formed in a plate-shaped manner.

20. A method according to claim 16, wherein the selective surface-treatment is carried out by chemical or electrolytic deposition, or combinations thereof, of at least one metallic coating.

21. A method according to claim 16, wherein the sealed and re-releasable connection of the first workpiece with at least one other workpiece is effected in such a way that as a result at least one surface of the first workpiece is covered by the connection over the whole or part of the surface.

22. A method according to claim 16, wherein at least some of the workpieces are produced from metal, ceramic material, polymers or combinations thereof.

23. A method according to claim 16, wherein at least the first workpiece is an equipped or non-equipped electrically non-conductive or almost non-conductive circuit-carrier and bears at least one metallization over the whole or part of at least one surface.

24. A method according to claim 16, wherein at least the first workpiece, but preferably also the other workpieces, are a ceramic-material/metal substrate.

25. A method according to claim 16, wherein at least the first workpiece is provided at one point with a metallization which is connected to the workpiece by a direct copper bonding (DCB) method or an active metal brazing (AMB) method.

26. A method according to claim 16, wherein for the re-releasable connection of the first workpiece with at least one other workpiece a frame- or plate-like connecting element is provided that corresponds to the negative contour of the surface of the first workpiece that is to be covered and on which the other workpieces are held with an adhesive, or gluing, sealing mass or with low pressure.

27. A method according to claim 16, wherein a plurality of temporally successive treatment phases of the same or a different selective surface-treatment, wherein before each treatment phase of the selective surface-treatment the workpieces are tightly connected together at their surface sides which are not to be treated.

28. A method according to claim 16, wherein a plurality of temporally successive treatment phases of the same or a different selective treatment, also subtractive processes, such as etching processes, are carried out on the regions which are not covered.

29. A method according to claim 16, wherein as a result of corresponding geometrical arrangement of the workpieces at the same time or alternately at least two different selective surface-treatments are carried out.

30. A method according to claim 16, wherein at least one workpiece is a ceramic heat sink.
